(19) United States
(12) Patent Application Publication
(10) Pub. No.: US 2015/0278448 A1
(43) Pub. Date: Oct. 1, 2015

(54) Method And Apparatus For Synchronizing A Clinical Context Across Applications

(71) Applicant: McKesson Financial Holdings, Hamilton (BM)

(72) Inventor: James R. Weegar, JR., Snellville, GA (US)

(73) Assignee: McKesson Financial Holdings, Hamilton (BM)

(21) Appl. No.: 14/228,710

(22) Filed: Mar. 28, 2014

(51) Int. Cl. G06F 19/00; G06F 17/30

(52) U.S. Cl. CPC G06F 19/322; G06F 17/30581; G06F 19/321; G06F 17/30864

(57) ABSTRACT

A method, apparatus and computer program product are provided in order to provide for synchronization of a clinical context across applications. An example method may include receiving an application context. The application context may include a clinical context of a first application. The method may also include determining, using a processor, a set of application execution parameters for a second application based on the application context. The application execution parameters may synchronize the clinical context of the first application with the second application. The method may also include executing the second application using the set of application execution parameters.

### TECHNOLOGICAL FIELD

An example embodiment of the present invention relates generally to remote management of applications and, more particularly, to executing a first application based on an application context determined from a second application.

### BACKGROUND

As network technology has advanced, it is increasingly common to remotely access applications that are hosted in data centers located far from client computers. These data centers allow for centralized storage and management of data, ensuring that proper access and security procedures are followed, and that such data is only provided to clients with proper credentials. For example, patient medical records are frequently maintained on server devices located remotely to the general purpose client personal computers used by medical practitioners to access the records. A given client may thus be used to access various remote applications, including applications located in different data centers.

However, in many cases, a client may wish to obtain data relating to a single context from multiple applications, including applications executing in different data centers. Such a scenario requires the user to separately execute each of the applications, and manually select the particular context from each application. For example, a medical practitioner may wish to obtain information relating to a particular patient encounter. The practitioner may first review the patient's records associated with the encounter in a first application, and then decide to view a medical imaging study associated with the same encounter. To do so, the practitioner would then execute the medical imaging application and reenter the same patient encounter identifier to view the imaging study. This approach thus requires the user to perform the same actions multiple times, such as logging in to each application and selecting the particular patient encounter. Performing each action for each application is inefficient. In the field of medicine, such inefficiencies can cause delays in patient treatment and, in some extreme situations, such inefficiencies may have a negative impact on patient outcomes if records take too long to access. Through applied effort, ingenuity, and innovation, Applicant has solved many of these identified problems by developing a solution that is embodied by the present invention, which is described in detail below

### BRIEF SUMMARY

A method, apparatus and computer program product are therefore provided according to an example embodiment of the present invention in order to synchronize a clinical context across applications. Embodiments may provide a method including receiving an application context, the application context comprising a clinical context of a first application, and determining, using a processor, a set of application execution parameters for a second application based on the application context. The application execution parameters synchronize the clinical context of the first application with the second application. The method further includes executing the second application using the set of application execution parameters. The method may further include receiving a selection of an interface control within the first application, and the application execution context may be provided by the first application in response to selection of an interface control within the first application. The clinical context may include at least one of a patient identifier, a patient encounter identifier, a procedure identifier, an observation identifier, a user identifier, or a medical imaging study identifier. The application context may include an application identifier associated with the second application, and the method may include selecting the second application from a plurality of applications based on the identifier. The first application may be a medical records application and the second application may be a picture archiving and communications system application. The application context may include a medical imaging study identifier identifying a particular medical imaging study. The first application may be hosted at a first remote data center and the second application is hosted at a second remote data center. The first application may be hosted at a first remote data center and the second application may be executed on a user device. The application context may be provided via a markup language. The method may further include selecting the second application from a plurality of applications based on a presence of a particular markup tag within the application context.

Embodiments may further include an apparatus. The apparatus may include processing circuitry configured to cause the apparatus to receive an application context, the application context comprising a clinical context of a first application, and to determine a set of application execution parameters for a second application based on the application context. The application execution parameters synchronize the clinical context of the first application with the second application. The processing circuitry may be further configured to cause the apparatus to execute the second application using the set of application execution parameters. The apparatus may be further caused to receive a selection of an interface control within the first application, and the application execution context may be provided by the first application in response to selection of an interface control within the first application The clinical context may include at least one of a patient identifier, a patient encounter identifier, a procedure identifier, an observation identifier, a user identifier, or a medical imaging study identifier. The application context may include an application identifier associated with the second application, and the apparatus may be further caused to select the second application from a plurality of applications based on the identifier. The first application may be a medical records application and the second application may be a picture archiving and communications system application. The application context may include a medical imaging study identifier identifying a particular medical imaging study. The first application may be hosted at a first remote data center and the second application may be hosted at a second remote data center. The first application may be hosted at a first remote data center and the second application may be executed on a user device. The application context may be provided via a markup language.

Yet further embodiments may provide a computer program product. The computer program product includes at least one computer-readable storage medium bearing computer program instructions embodied therein for use with a computer. The computer program instructions include program instructions configured to receive an application context. The application context includes a clinical context of a first application. The computer program product may further include instructions to determine a set of application execution parameters for a second application based on the application context. The application execution parameters synchronize the clinical context of the first application with the second application. The computer program product may also include program instructions configured to execute the second application using the set of application execution parameters.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is a block diagram of an apparatus that may be specifically configured in accordance with example embodiments of the present invention;

FIG. 2 is a block diagram of application servers in communication with a client device in accordance with example embodiments of the present invention;

FIG. 3 is an illustration of an example data flow for determining an application execution context in accordance with example embodiments of the present invention;

FIG. 4 is an illustration of an example interface including an interface control for determining an application execution context in accordance with example embodiments of the present invention;

FIG. 5 is a flow diagram of an example method for capturing an application execution context in accordance with embodiments of the present invention; and

FIG. 6 is a flow diagram of an example method for executing an application based on a determined application execution context in accordance with embodiments of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout

### Introduction and Definitions

A method, apparatus and computer program product are provided in accordance with an example embodiment of the present invention in order to provide an execution context for an application. In this regard, a method, apparatus and computer program product of an example embodiment may determine an application context from a first application executing on a first remote device. The application context may relate to one or more documents or records being accessed by the user via the first application. The application context may be passed from the first application to a user device. The user device may utilize the application context to invoke a second application executing on a second remote device or on the local user device using a set of execution parameters derived from the application context. The second application may utilize the execution parameters to provide the user with one or more documents or records related to the set of documents or records accessed by the user in the first application. For example, embodiments may provide users with the ability to obtain related patient medical histories, imaging studies, or other medical records from a second application via selection of an interface control in a first application, such that the records displayed in the second application pertain to records originally accessed in the first application.

For the purpose of this application, the term “application context” means information describing a particular data item, record, set of records, or the like as accessed using a particular application. For example, the application context for a patient medical record may include information identifying the patient, a particular clinical encounter, a particular procedure, an observation, a group of patients, encounters, or procedures, a set of search results, a set of records associated with a particular type of procedure, or the like. The application context may also include information the uniquely identifies the user of the computer or computer application such as user identifier(s) including a username, a user account, a user id, a screen name, or the like. It should be appreciated that while the application context and embodiments of the present invention are generally described with reference to examples in a medical or clinical field, embodiments could be employed in a variety of industries using a variety of technologies. As such, the scope of the embodiments described herein should be understood not to be limited to the clinical field, as embodiments may be equally applicable to any scenario in which applications are hosted on a first computing node and executed on a different computing node other than the first computing node.

### Example Apparatus

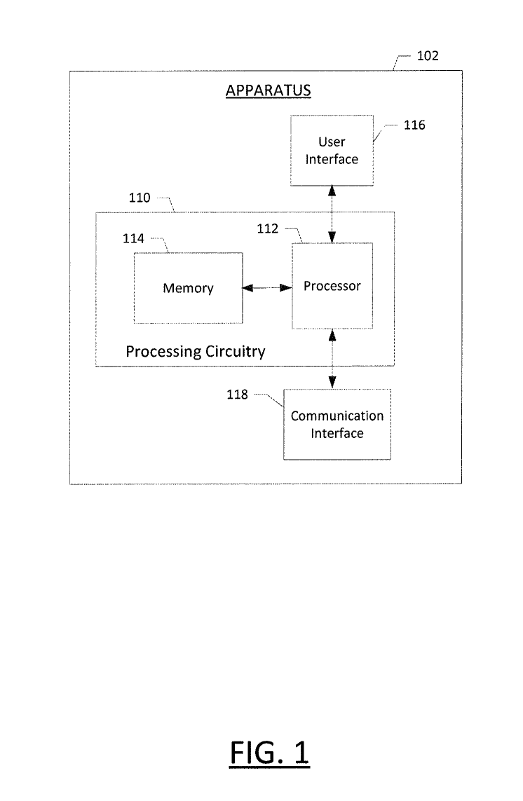

FIG. 1 illustrates a block diagram of an apparatus 102 in accordance with some example embodiments. The apparatus 102 may be any computing device capable of hosting an application or providing client access to a server-based application as described herein. For example, the apparatus 102 may be implemented as a server (e.g., an application server implemented as a standalone or rack-mounted server), a smart phone, a personal digital assistant, a tablet computer, a netbook computer, a laptop, or a desktop. The apparatus 102 may be operable to determine and/or receive an application context, and to determine application execution parameters based on the application context. Accordingly, it will be appreciated that the apparatus 102 may comprise an apparatus configured to implement and/or otherwise support implementation of various example embodiments described herein.

It should be noted that the components, devices or elements illustrated in and described with respect to FIG. 1 below may not be mandatory and thus some may be omitted in certain embodiments. Additionally, some embodiments may include further or different components, devices or elements beyond those illustrated in and described with respect to FIG. 1.

The apparatus 102 may include or otherwise be in communication with processing circuitry 110 that is configurable to perform actions in accordance with one or more example embodiments disclosed herein. In this regard, the processing circuitry 110 may be configured to perform and/or control performance of one or more functionalities of the apparatus 102 (e.g., functionalities of a computing device on which the apparatus 102 may be implemented) in accordance with various example embodiments, and thus may provide means for performing functionalities of the apparatus 102 (e.g., functionalities of a computing device on which the apparatus 102 may be implemented) in accordance with various example embodiments. The processing circuitry 110 may be configured to perform data processing, application execution and/or other processing and management services according to one or more example embodiments. In some embodiments, the apparatus 102 or a portion(s) or component(s) thereof, such as the processing circuitry 110, may be embodied as or comprise a chip or chip set. In other words, the apparatus 102 or the processing circuitry 110 may comprise one or more physical packages (e.g., chips) including materials, components and/or wires on a structural assembly (e.g., a baseboard). The apparatus 102 or the processing circuitry 110 may therefore, in some cases, be configured to implement an embodiment of the invention on a single chip or as a single “system on a chip.” As such, in some cases, a chip or chipset may constitute means for performing one or more operations for providing the functionalities described herein.

In some example embodiments, the processing circuitry 110 may include a processor 112 and, in some embodiments, such as that illustrated in FIG. 1, may further include memory 114. The processing circuitry 110 may be in communication with or otherwise control a user interface 116 and/or a communication interface 118. As such, the processing circuitry 110 may be embodied as a circuit chip (e.g., an integrated circuit chip) configured (e.g., with hardware, software or a combination of hardware and software) to perform operations described herein.

The processor 112 may be embodied in a number of different ways. For example, the processor 112 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. Although illustrated as a single processor, it will be appreciated that the processor 112 may comprise a plurality of processors. The plurality of processors may be in operative communication with each other and may be collectively configured to perform one or more functionalities of the apparatus 102 as described herein. The plurality of processors may be embodied on a single computing device or distributed across a plurality of computing devices collectively configured to function as the apparatus 102. In some example embodiments, the processor 112 may be configured to execute instructions stored in the memory 114 or otherwise accessible to the processor 112. As such, whether configured by hardware or by a combination of hardware and software, the processor 112 may represent an entity (e.g., physically embodied in circuitry—in the form of processing circuitry 110) capable of performing operations according to embodiments of the present invention while configured accordingly. Thus, for example, when the processor 112 is embodied as an ASIC, FPGA or the like, the processor 112 may be specifically configured hardware for conducting the operations described herein. Alternatively, as another example, when the processor 112 is embodied as an executor of software instructions, the instructions may specifically configure the processor 112 to perform one or more operations described herein.

In some example embodiments, the memory 114 may include one or more non-transitory memory devices such as, for example, volatile and/or non-volatile memory that may be either fixed or removable. In this regard, the memory 114 may comprise a non-transitory computer-readable storage medium. It will be appreciated that while the memory 114 is illustrated as a single memory, the memory 114 may comprise a plurality of memories. The plurality of memories may be embodied on a single computing device or may be distributed across a plurality of computing devices collectively configured to function as the apparatus 102. The memory 114 may be configured to store information, data, applications, instructions and/or the like for enabling the apparatus 102 to carry out various functions in accordance with one or more example embodiments. For example, the memory 114 may be configured to buffer input data for processing by the processor 112. Additionally or alternatively, the memory 114 may be configured to store instructions for execution by the processor 112. As yet another alternative, the memory 114 may include one or more databases that may store a variety of files, contents or data sets. Among the contents of the memory 114, applications may be stored for execution by the processor 112 in order to carry out the functionality associated with each respective application. In some cases, the memory 114 may be in communication with one or more of the processor 112, user interface 116, or communication interface 118 via a bus or buses for passing information among components of the apparatus 102.

The user interface 116 may be in communication with the processing circuitry 110 to receive an indication of a user input at the user interface 116 and/or to provide an audible, visual, mechanical or other output to the user. As such, the user interface 116 may include, for example, a keyboard, a mouse, a joystick, a display, a touch screen display, a microphone, a speaker, a Light Emitting Diode (LED), a lighting device, and/or other input/output mechanisms.

The communication interface 118 may include one or more interface mechanisms for enabling communication with other devices and/or networks. In some cases, the communication interface 118 may be any means such as a device or circuitry embodied in either hardware, or a combination of hardware and software that is configured to receive and/or transmit data from/to a network and/or any other device or module in communication with the processing circuitry 110. By way of example, the communication interface 118 may be configured to enable the apparatus 102 to communicate with another computing device via a wireless network, such as a wireless local area network (WLAN), cellular network, and/or the like. Additionally or alternatively, the communication interface 118 may be configured to enable the apparatus 102 to communicate with another computing device via a wireline network. In some example embodiments, the communication interface 118 may be configured to enable communication between the apparatus 102 and one or more further computing devices via the Internet. Accordingly, the communication interface 118 may, for example, include an antenna (or multiple antennas) and supporting hardware and/or software for enabling communications with a wireless communication network (e.g., a wireless local area network, a Bluetooth network, a cellular network, and/or the like) and/or a communication modem or other hardware/software for supporting communication via cable, digital subscriber line (DSL), universal serial bus (USB), Ethernet or other methods.

Having now described an apparatus configured to implement and/or support implementation of various example embodiments, features of several example embodiments will now be described. It will be appreciated that the following features are non-limiting examples of features provided by some example embodiments. Further, it will be appreciated that embodiments are contemplated within the scope of disclosure that implement various subsets or combinations of the features further described herein. Accordingly, it will be appreciated that some example embodiments may omit one or more of the following features and/or implement variations of one or more of the following features.

### Example System Architecture

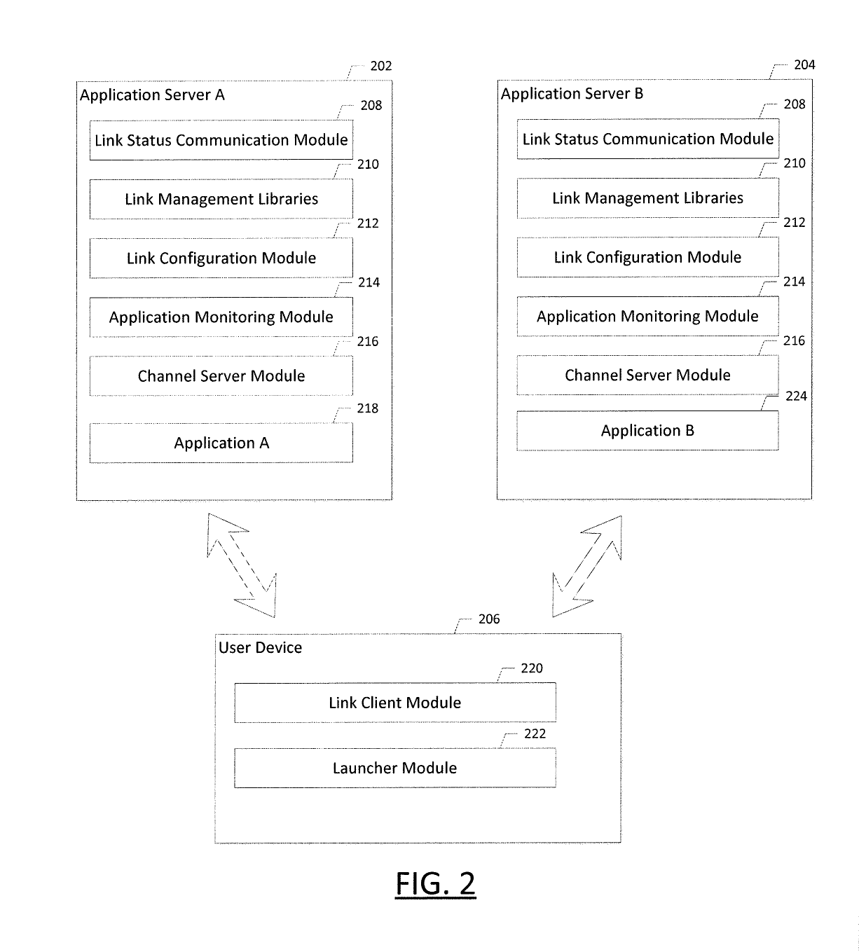

FIG. 2 is a block diagram of a system architecture in accordance with example embodiments of the present invention. The illustration depicts a user device 206 in communication with two application servers, application server A 202 and application server B 204. Each of the user device and application servers may be embodied in or as a computing device as described above with respect to the apparatus 102. For example, application server A 202 and application server B 204 may be implemented on or as physical or virtual servers at respective data centers, and the user device 206 may be implemented as a laptop, cellular phone, personal digital assistant, smartphone, desktop, tablet, server, or netbook computer. It should be appreciated that, in some embodiments, various other configurations of computing devices could also be implemented, such as both application server A 202 and application server B 204 being embodied on a single apparatus (e.g., two servers within the same rack, or two virtual machines on the same hardware).

The application server A 202 may include a plurality of modules, implemented in hardware, software, or a combination thereof, to facilitate performance of embodiments of the present invention. The application server A 202 may include a link status communication module 208, a set of link management libraries 210, a link configuration module 212, an application monitoring module 214, a channel server module 216 and an application A 218. The application A 218 may refer to any application hosted on the application server A 202. The application A 218 may provide access to one or more sets of data, such as medical record data stored in a database (not shown). The application A 218 may be operable to provide the user device 206 with information according to a particular application context, such as a particular identified record, set of records, record search parameters, or the like. The application A 218 may include one or more interface controls that, when selected via the user device 206, cause the application context to be captured. In some embodiments, the application context may further include a particular application to be executed. For example, when viewing a set of patient medical records, an interface control may be used to launch a picture archive and communications system (PACS) application to view an imaging study associated with the patient medical records. In some embodiments, particular interface controls may be associated with particular second applications, and selection of those interface controls may cause capturing of the application context and launching of the particular second application. For example, a patient medical records application might include a first interface control to launch a PACS application associated with an imaging study for a given set of patient records, and a second interface control to launch a web browser with more information about a particular condition, symptom, or diagnosis associated with a record being viewed in the patient medical records application.

Capturing of the application context may be performed through the use of the application monitoring module 214 in conjunction with the link management libraries 210. The application monitoring module 214 may act as a server-side monitor for input to the application A 218 through a virtual channel maintained by the channel server module 216. For example, in some embodiments, communication between the application server A 202 and the user device 206 is performed via a Citrix® virtual channel provided by the channel server module 216, which provides one or more channels for transmission of information between the application servers and the user device 206. Upon selection of an interface control within the application A 218, a library function (e.g., a browser helper object) may be called by the application A 218 to communicate the application context to the application monitoring module 214, and the application monitoring module 214 may transmit the application context to the user device 206 via a transmission channel provided by the a channel server module 216. Although the channel maintained by the channel server module 216 is primarily described as providing application context data, it should also be appreciated that various additional or alternative information could also be provided over the channel such as, but not limited to, user identity or login information, user inputs (e.g., keystrokes and/or mouse movements), or the like.

In some embodiments, the application monitoring module 214 may format the application context in a markup language format, such as extensible markup language (XML). The application monitoring module 214 may execute to notify the user device 206 of the application context via the channel provided by the channel server module 216. As an example, application context data provided to the user device 206 may include the following parameters and information:

TABLE 1

| Parameter | Usage |
|---|---|
| <debugMode> | Used to turn on logging by the user device. |
| | Valid values include “on” and “off”. |
| | Default value is “off”. |
| <appAction> | Used to command the user device to launch or |
| | shutdown an application running on the end- |
| | user device. Valid values include “start” or |
| | “stop”. The default value is “stop”. |
| <appId> | Used to uniquely identify the application |
| | started on the user device. Valid values include |
| | any unique string. |
| <appName> | Used to start a process on the user device. |
| | Valid values include any valid process name |
| | on the end-user device. |
| <appCmdLine> | Used to pass parameters to the process |
| | identified by <appName>. |
| <appCurrentDirectory> | Used to set the current directory for the process |
| | identified by <appName>. |

The following is an example structure that may be used to transmit the application context information defined by these example parameters:

TABLE 2

<VirtualChannelData>

<debugMode></debugMode>
<appAction></appAction>
<appId></appId>
<appName></appName>
<appCmdLine></appCmdLine>
<appCurrentDirectory></appCurrentDirectory>

</VirtualChannelData>

As a particular example, a structure instructing the user device to execute a particular web browser (e.g., “browser.exe”) and navigate to a particular website (e.g., www.mckesson.com) could take the form as follows:

TABLE 3

<VirtualChannelData>

<debugMode>on</debugMode>
<appAction>start</appAction>
<appId>McKessonWebSite</appId>
<appName>browser.exe</appName>
<appCmdLine>http://www.mckesson.com</appCmdLine>
<appCurrentDirectory></appCurrentDirectory>

</VirtualChannelData>

As described above, the application server A 202 may also include a link status communication module 208. The link status communication module 208 may provide for sending and receiving status and support messages to an external process, server, or device for diagnostic, logging, and management functions of the application monitoring module 214.

The application server A 202 may further include a link configuration module 212 which may assist with configuring the application monitoring module 214, the link management libraries 210, or other aspects of the channel for providing the application context to the user device. The link configuration module 212 may facilitate modification of various configuration settings. These configuration settings may include, for example, web site URLs for the application monitoring module 214 to automatically recognize and pass these URLs through the channel server module 216 for display on the user device 206 or application server B 204. Another example of configuration settings may be a setting that determines automatic mapping of one web site URL to another (e.g., a first website URL provided by the application server A 202 being mapped to a second web site URL for the application server B 204 or the user device 206) which may be necessary for successful access of the web site when browsing from the user device 206 versus application server A 202 or application server B 204. Such a translation may need to be performed for various reasons, including but not limited to performing network address translation.

The application context may be received by the user device 206 over a channel associated with the application monitoring module 214. The user device 206 side of the channel may be monitored by a link client module 220. The link client module 220 may be implemented as a library or set of libraries (e.g., a device driver) that monitors the virtual channel to receive the application context. The link client module 220 may process incoming application contexts received on the channel and provide the application context to a launcher module 222.

The launcher module 222 may receive the incoming application context and identify an application to be launched and any launch parameters for the application to be launched. For example, the application context received from the application server A 202 may specify a particular application and a particular record or set of records to be accessed by the application. The launcher module 222 may format the set of records into a set of execution parameters for the particular application and execute the particular application with that set of execution parameters. It should also be readily appreciated that formatting of the application context into execution parameters may be performed at various other points of the process. For example, the original application that supplied the context may determine the execution parameters, or the link client module 220 may determine the execution parameters prior to providing the application context to the launcher module 222. As such, the application execution parameters may be determined by the original application (e.g., the application containing the interface control that causes execution of the second application), or by various modules or processes of the user device.

In some embodiments, the launcher module 222 may present the user with a menu notifying the user of one or more applications that are available for execution based on the received context. For example, the menu may receive multiple elements of context data as part of the application context, such as different identifiers for patient encounters, patient imaging studies, patient identities, or other context elements as described above. The launcher module 222 may identify the presence of these particular elements of context data and allow the user to choose which applications are executed using the context data. In some embodiments, the user may be presented with a menu naming each application and the relevant context data available for each. This menu may further provide the user with the option to select which context data is used by each application to determine execution parameters for that particular application. It should also be appreciated that this determination could be performed at the time the context information is gathered, rather than by the launcher module 222.

The launcher module 222 may execute one or more applications on the application server B 204 in accordance with the execution parameters. As with the application server A 202, the application server B 204 may include a link status communication module 208, a set of link management libraries 210, a link configuration module 212, an application monitoring module 214, and a channel server module 216. The application server B 204 may further execute an application B 224, which is the application to be launched via the launcher application 220 on the user device 206. The application server B 204 may receive the execution command from the user device 206 with the execution parameters derived from the application context, and execute the application B 224 with said execution parameters. In this manner, an application context derived on a first server (e.g., the application server A 202) can be utilized to launch a particular application on a second server (e.g., the application server B 204). It should be appreciated that in some embodiments, the execution parameters may include instructions to execute or terminate execution of a particular application, without any further action.

### Example Data Flow

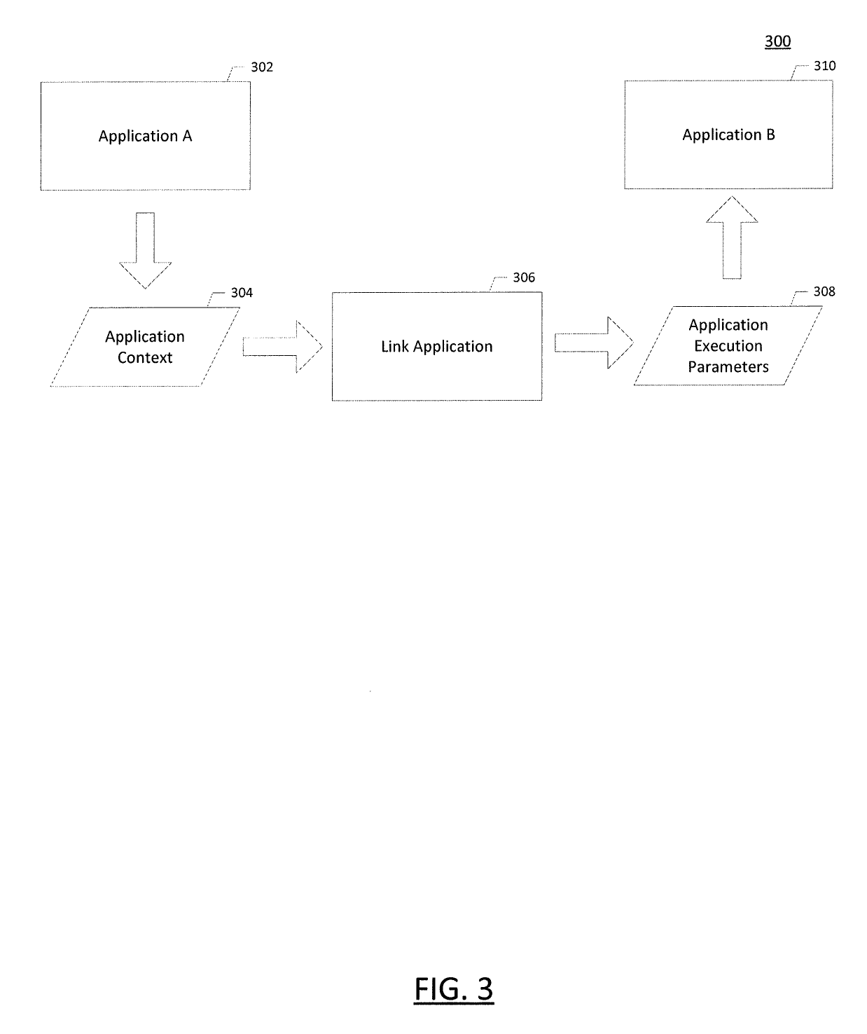

FIG. 3 is an illustration of an example data flow 300 among components in accordance with some example embodiments of the present invention. The data flow 300 illustrates how an application context 304 can be derived from a first application, application A 302, and used to generate a set of execution parameters 308 for a second application, application B 310.

In the present example, an application context 304 is received from application A 302. The application context 304 may be determined and transmitted from the application A 302 in accordance with the infrastructure described above with respect to FIG. 2 (e.g., via a channel established between a server and a user device). As described above, the application context may include information identifying a particular execution state of application A 302, such as a particular record, set of records, patient encounter, medical procedure, or the like being viewed or interacted with by the user via application A 302. The application context 304 may further specify a particular second application (e.g., which application should be executed based on the context). Alternatively, the second application may be determined by a link application 306 based on the application context.

The application context 304 may be received by a link application 306. In some embodiments, the functionality of the link application is performed by one or more of the link client module 220 and/or the launcher module 222 described above with respect to FIG. 2. The link application 306 may use the application context to derive a set of application execution parameters 308 for a second application, application B 310. The link application 306 may determine these execution parameters by parsing data contained within the application context. For example, as described above, the application context 304 may include parameters specifying the particular second application and the particular parameters to use for execution. Alternatively, the link application may determine which application to execute and which execution parameters to use based on other information provided in the application context. For example, the application context may include a value identifying a particular patient, medical encounter, procedure, symptom, or the like, within a parameter tag corresponding to the type of value. The link application 306 may identify that the application context contains this information and generate application execution parameters for the appropriate application.

As a specific example, the application context may include a value tied to a particular medical imaging study. The link application may note that the application context contains a parameter tag “<ImagingStudy>” with a corresponding value identifying the particular imaging study. Upon detection of this parameter and value pair, the link application may execute a PACS application with execution parameters (e.g., command line arguments) that cause the PACS application to open the study identified by the tag, value pair for viewing. Alternatively, or additionally, a parameter tag may indicate a particular user, patient, encounter, observation, or the like, and cause a relevant application to be launched based on the presence of the tag. In some embodiments, passing a particular tag in the application context may result in the user device attempting to execute a particular application. If execution of the particular application fails on the client, then the launcher device may attempt to execute the particular application on an application server.

The application execution parameters 308 are used to execute the application B 310 such that the context of application B 310 is synchronized with the application context 304 provided by application A 302. This synchronization may result in both application A 302 and application B 310 being opened to records for the same patient, records for the same procedure, records for the same imaging study, or the like. In this manner, the user does not have to manually look up and access the information within application B 310 to obtain additional information associated with the context viewed in application A 302.

### Example Interface Illustrations

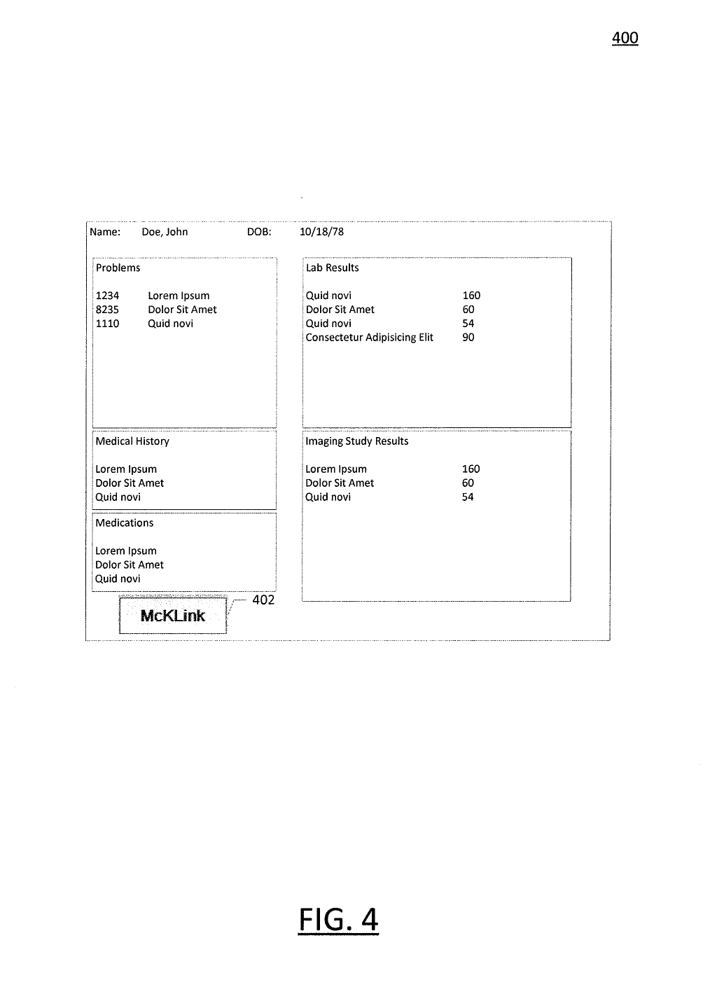

FIG. 4 is an illustration of an example interface 400 for capturing an application context and launching an application on a remote server using the application context. The interface 400 depicts an electronic health record interface viewing a record for a particular patient, “John Doe”. The interface 400 includes an interface control 402 that facilitates execution of an external application in accordance with the embodiments described herein. For example, in the present context, the interface control 402 is a button that, when selected by the user, causes another application to be executed. Selecting this interface control 402 may provide the context of the current application (e.g., an identifier for the particular patient being viewed) and execute another application (e.g., an imaging study viewing application) for the same patient. It should also be appreciated that the context may determine which applications are executed additionally or alternatively to providing execution parameters to the application to be executed. For example, if the patient electronic health record being viewed in the interface 400 contains an imaging study, then selection of the interface control 402 may open an imaging study viewing application, while if the electronic health record does not, then a different application may be executed (e.g., another electronic health records application with access to a different patient database to identify matching records in the different database). It should be appreciated that in some embodiments, selection of the interface control may present a user with a menu of all applications that are relevant to the particular context. For example, the menu may allow the user to select which of the aforementioned imaging study viewing application and alternative medical records applications the user wishes to execute. As a further example, such a menu might notify the user of which elements of the current context would be provided to each application selected, such as providing an identifier for an imaging study to the imaging study viewing application, and a patient identifier to the alternative electronic health records application.

### Example Methods for Application Execution

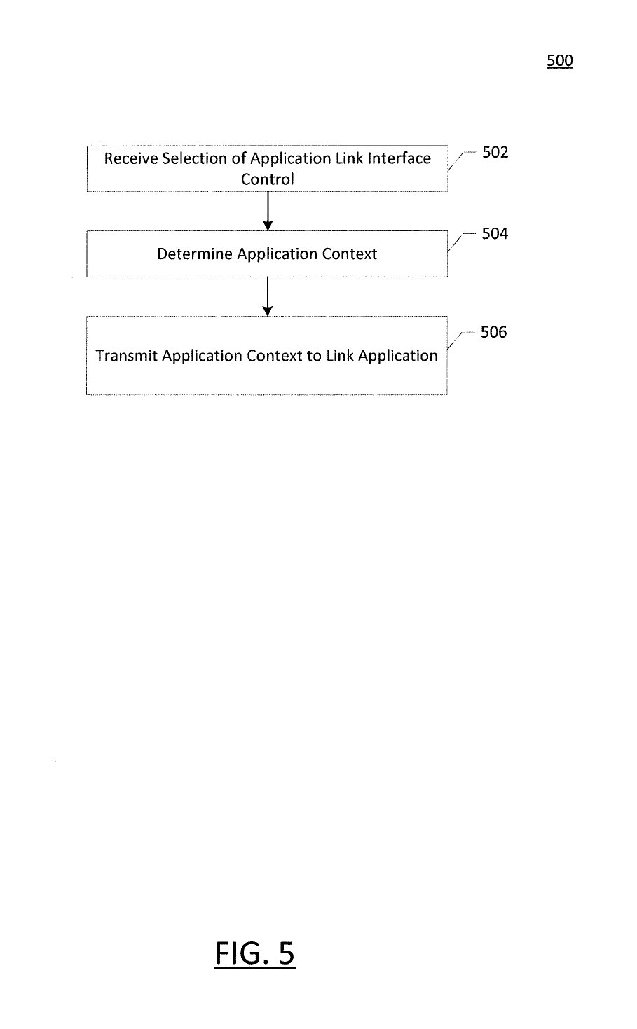

FIG. 5 is a flow diagram of an example method 500 for capturing an application execution context in accordance with embodiments of the present invention. As described above, embodiments may function to capture an application context from a first application for use in determining execution parameters for a second application. This application context may be utilized to synchronize the context of the first application and the second application, such as by displaying related records (e.g., to the same patient, patient encounter, or the like) on both applications, or launching a second application to provide additional information about a concept present in the first application (e.g., launching an imaging study or opening a medical reference library for a particular procedure, symptom, or the like). Embodiments of the method 500 may be implemented using an apparatus, such as the apparatus 102 and/or the application servers 202, 206 or the user device 204 described above with respect to FIGS. 1 and 2.

At action 502, a selection of an application link interface control is received. For example, a user may select a button, checkbox, or other interface control within the first application. This interface control may specify that it will launch another application, or search for information related to a displayed record in another application.

At action 504, a context for the application is determined. As described above, the context may be determined by one or more library functions executing in response to selection of the application link interface control. Determining the context may include identifying which record or records are displayed, recently viewed, or otherwise accessed by the user in the first application. In some examples, particular interface controls are provided for particular application contexts. For example, a display may list multiple patient records, with a separate interface control associated with each record. In some embodiments, the application context may be identified based on a series of checkboxes associated with patient records. For example, a user may be viewing a list of 20 records, and select checkboxes associated with 5 of the 20 records. Upon selection of the interface control, the application context may be determined from the 5 selected records, excluding the 15 unselected records. In some embodiments, the application context may further specify a particular application or type of application. For example, an interface control associated with viewing a medical imaging study may include identification of a particular imaging application. Alternatively, the application context may include a parameter indicating the context contains a study, without specifying a particular application.

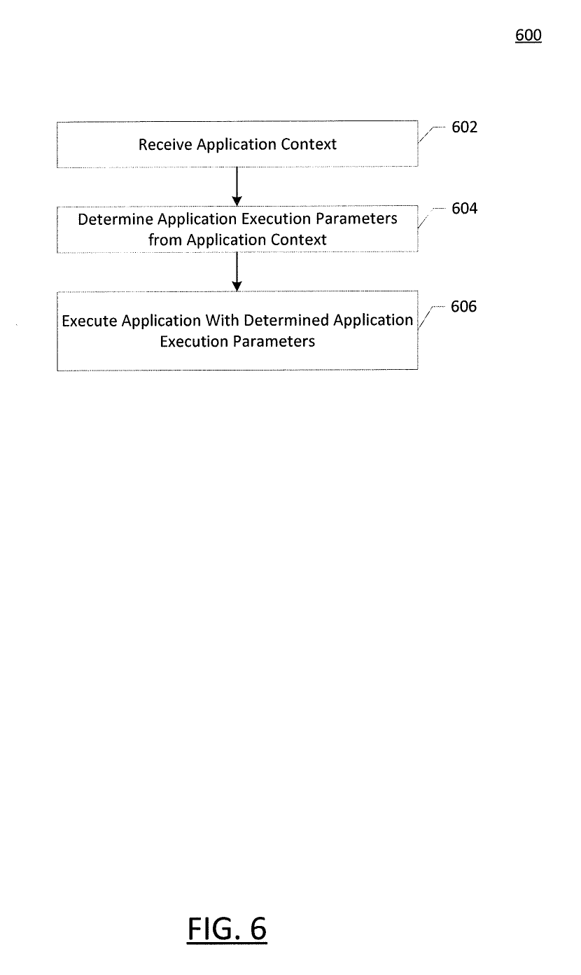

At action 506, the application context is transmitted to a link application, such as a link application executing on a user device as described above with respect to FIGS. 2 and 3. The application context may be received and processed by the user device in accordance with an example method described below with respect to FIG. 6.

FIG. 6 is a flow diagram of an example method 600 for executing an application based on a determined application execution context in accordance with embodiments of the present invention. As described above, an application context for a first application may be used to derive a set of execution parameters for a second application in order to synchronize elements of the first application with the second application. The method 600 illustrates how a received application context may be processed to derive the execution parameters and the execution parameters may be used to execute the second application. Embodiments of the method 600 may be implemented using an apparatus, such as the apparatus 102 and/or the application servers 202, 206 or the user device 204 described above with respect to FIGS. 1 and 2.

At action 602, an application context is received. As described above, the application context may be received via a channel established between a user device and an application executing on a remote server. The application context may be of a form and/or structure as described above with respect to FIG. 2. For example, the application context may be encoded in a markup language with markup tags used to indicate relevant values of the application context.

At action 604, the application context may be used to determine a set of application execution parameters. For example, as described above, the particular tag types and values within the application context may be used to construct a set of command line execution parameters for a second application. These command line parameters may instruct an application to perform particular tasks, such as to open a particular record or set of records for viewing, or to perform a login operation with a user name and password indicated by the first application. As described above, the application context may specify a particular second application, or determining the second application may be performed by parsing the application context. For example, particular tag types may be associated with particular applications, and the presence of such a tag type (e.g., a tag indicating an imaging study) may identify a particular application (e.g., a PACS application) as the application to be executed by the application execution parameters. As additional examples, if a file name is passed as part of the context information, then embodiments may determine which application to launch by the file extension (e.g., .docx for Microsoft Word®, .xlsx for Microsoft Excel®, .pptx for Microsoft PowerPoint®, .txt for Microsoft Notepad® or the like).

Embodiments may also format application command line parameters to launch specific applications. For example, the application providing the application context may not know the command line parameters required by the executed application. If the application providing the application context knows that it needs to launch the second application, the launcher module 222 configuration file may have the required command line parameter format and create the command line one-the-fly when generating the application execution parameters.

At action 606, an application is executed using the application execution parameters determined at action 604. For example, a remote application may be executed with command line parameters that open the remote application and display records associated with the same patient as indicated in the application context. In this manner, embodiments of the invention may synchronize a context of two applications, such as, for example, a clinical context relating to a set of patient medical records.

It will be understood that each element of the flowchart, and combinations of elements in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory 114 of an apparatus employing an embodiment of the present invention and executed by a processor 112 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
receiving an application context, the application context comprising a clinical context of a first application;
determining, using a processor, a set of application execution parameters for a second application based on the application context, wherein the application execution parameters synchronize the clinical context of the first application with the second application; and
executing the second application using the set of application execution parameters.

2. The method of claim 1, further comprising receiving a selection of an interface control within the first application, and wherein the application execution context is provided by the first application in response to selection of an interface control within the first application.

3. The method of claim 1, wherein the clinical context comprises at least one of a patient identifier, a patient encounter identifier, a procedure identifier, an observation identifier, a user identifier, or a medical imaging study identifier.

4. The method of claim 1, wherein the application context comprises an application identifier associated with the second application, and wherein the method further comprises selecting the second application from a plurality of applications based on the identifier.

5. The method of claim 1, wherein the first application is a medical records application and the second application is a picture archiving and communications system application.

6. The method of claim 5, wherein the application context comprises a medical imaging study identifier identifying a particular medical imaging study.

7. The method of claim 1, wherein the first application is hosted at a first remote data center and the second application is hosted at a second remote data center.

8. The method of claim 1, wherein the first application is hosted at a first remote data center and the second application is executed on a user device.

9. The method of claim 1, wherein the application context is provided via a markup language.

10. The method of claim 9, further comprising selecting the second application from a plurality of applications based on a presence of a particular markup tag within the application context.

11. An apparatus comprising processing circuitry configured to cause the apparatus to:
receive an application context, the application context comprising a clinical context of a first application;
determine a set of application execution parameters for a second application based on the application context, wherein the application execution parameters synchronize the clinical context of the first application with the second application; and
execute the second application using the set of application execution parameters.

12. The apparatus of claim 11, further caused to receive a selection of an interface control within the first application, wherein the application execution context is provided by the first application in response to selection of an interface control within the first application.

13. The apparatus of claim 11, wherein the clinical context comprises at least one of a patient identifier, a patient encounter identifier, a procedure identifier, an observation identifier, a user identifier, or a medical imaging study identifier.

14. The apparatus of claim 11, wherein the application context comprises an application identifier associated with the second application, and wherein the apparatus is further caused to select the second application from a plurality of applications based on the identifier.

15. The apparatus of claim 11, wherein the first application is a medical records application and the second application is a picture archiving and communications system application.

16. The apparatus of claim 15, wherein the application context comprises a medical imaging study identifier identifying a particular medical imaging study.

17. The apparatus of claim 11, wherein the first application is hosted at a first remote data center and the second application is hosted at a second remote data center.

18. The apparatus of claim 11, wherein the first application is hosted at a first remote data center and the second application is executed on a user device.

19. The apparatus of claim 11, wherein the application context is provided via a markup language.

20. A computer program product comprising at least one computer-readable storage medium bearing computer program instructions embodied therein for use with a computer, the computer program instructions comprising program instructions configured to:
receive an application context, the application context comprising a clinical context of a first application;
determine a set of application execution parameters for a second application based on the application context, wherein the application execution parameters synchronize the clinical context of the first application with the second application; and
execute the second application using the set of application execution parameters.
